(19) United States
(12) Patent Application Publication
(10) Pub. No.: US 2026/0097304 A1
(43) Pub. Date: Apr. 9, 2026

(54) NON-TRANSITORY COMPUTER-READABLE MEDIUM, INFORMATION PROCESSING SYSTEM, AND INFORMATION PROCESSING METHOD

(71) Applicant: NINTENDO CO., LTD., Kyoto-shi (JP)

(72) Inventors: Takumi SAITO, Kyoto (JP); Jun ITO, Kyoto (JP)

(21) Appl. No.: 19/350,286

(22) Filed: Oct. 6, 2025

(30) Foreign Application Priority Data
Oct. 9, 2024 (JP) 2024-177158

(51) Int. Cl. A63F 13/428; A63F 13/422; A63F 13/47; A63F 13/55; A63F 13/803

(52) U.S. Cl. CPC A63F 13/428; A63F 13/422; A63F 13/47; A63F 13/55; A63F 13/803

(57) ABSTRACT

In an example of the exemplary embodiment, based on an operation input, movement control including control to change a movement direction in accordance with at least an input amount is performed for a player object in a field in a virtual space in which a course path is defined. Where both ends at a position on the course path advanced by a predetermined distance along the course path from a position of the player object during movement are defined as first and second positions, if the movement direction of the player object is not included between a first direction toward the first position from the position during the movement and a second direction toward the second position from the position during the movement, correction is applied to the input amount so that the movement direction becomes close to a third direction included at least between the first and second directions.

### CROSS REFERENCE TO RELATED APPLICATION

This application claims priority to Japanese Patent Application No. 2024-177158, filed on Oct. 9, 2024, the entire contents of which are incorporated herein by reference.

### FIELD

The technique shown here relates to a computer-readable non-transitory medium having stored therein a game program, an information processing system, an information processing method, and an information processing apparatus that enable a player object to move in a virtual space.

### BACKGROUND AND SUMMARY

Conventionally, there is a game system that performs correction for supporting a player in a game in which a player object is moved.

In the conventional system, there is room for improvement in correction for the movement direction of a player object, in order to perform appropriate correction adaptably to a course having a great width, for example.

The exemplary embodiment discloses a computer-readable non-transitory medium having stored therein a game program, an information processing system, an information processing method, and an information processing apparatus that enable correction to be performed more appropriately.

### First Configuration

In a first configuration of the exemplary embodiment, one or more non-transitory computer-readable media have stored therein instructions that, when executed, cause one or more processors to execute game processing including: based on an operation input, performing movement control for a player object in a field in a virtual space in which a course path indicating at least both ends of a course is defined along the course, the movement control including control to change a movement direction in accordance with at least an input amount; and where both ends at a position on the course path advanced by a predetermined distance along the course path from a position of the player object during movement are defined as a first position and a second position, if the movement direction of the player object is not included between a first direction toward the first position from the position during the movement and a second direction toward the second position from the position during the movement, applying correction to the input amount so that the movement direction becomes close to a third direction included at least between the first direction and the second direction.

With the above configuration, it is possible to perform correction so that the player object moves toward a position advanced along the course path, and thus it is possible to perform correction appropriately even in a case where the course width is great.

### Second Configuration

In a second configuration based on the first configuration, the third direction may be a direction closer to the movement direction before the correction, of the first direction and the second direction.

With the above configuration, it is possible to perform minimum necessary correction so as not to cause an unnatural result.

### Third Configuration

In a third configuration based on the first or second configuration, the course may include a part splitting into a plurality of course paths. The game processing may include, in a case where a position on the course path advanced by a predetermined distance along the course path is at the splitting part, setting an end on one side of the course path that is on the one side as the first position and setting an end on another side of the course path that is on the other side as the second position.

With the above configuration, it is possible to appropriately perform correction at the part splitting into the plurality of course paths.

### Fourth Configuration

In a fourth configuration based on any one of the first to third configurations, the game processing may further include, in a case where the movement direction of the player object is deviated from an advancement direction on the course path by a predetermined criterion or more, correcting the input amount or the movement direction so that the movement direction of the player object becomes close to the advancement direction on the course path.

With the above configuration, in a case where the movement direction of the player object is deviated from the advancement direction by the predetermined criterion or more, the input amount or the movement direction of the player object can be corrected so that the movement direction becomes close to the advancement direction on the course path.

### Fifth Configuration

In a fifth configuration based on any one of the first to fourth configurations, the both ends of the course path may be defined based on curves prescribed by a plurality of discrete control points.

With the above configuration, both ends of the course path can be defined based on a plurality of discrete control points, and the correction can be performed based on smooth curves.

Other configurations may be an information processing system, an information processing apparatus, or an information processing method for executing the above game program.

According to one example of the exemplary embodiment, it is possible to perform correction so that the player object moves toward a position advanced along the course path.

These and other features, aspects, and advantages of the subject matter described herein will become more apparent from the following detailed description when taken in conjunction with the accompanying drawings.

### BRIEF DESCRIPTION OF THE DRAWINGS

FIG. 1 is an example non-limiting diagram showing an example of a game system;

FIG. 2 is an example non-limiting block diagram showing an example of the internal configuration of a main body apparatus;

FIG. 3 is an example non-limiting diagram showing an example of a course in which a racing game is performed in an exemplary embodiment;

FIG. 4 is an example non-limiting diagram showing an example of a game image displayed on a screen during the racing game;

FIG. 5 is an example non-limiting diagram showing a part of a course and illustrating a course path;

FIG. 6 is an example non-limiting diagram illustrating movement correction in an assist function in the exemplary embodiment;

FIG. 7 is an example non-limiting diagram illustrating movement correction in a case where two course paths overlap each other;

FIG. 8 is an example non-limiting diagram illustrating an example of movement correction when a player object 50 is present on a lower course path in a case where two course paths having a height difference are adjacent to each other;

FIG. 9 is an example non-limiting diagram illustrating an example of movement correction when the player object 50 is present on a higher course path in a case where two course paths having a height difference are adjacent to each other;

FIG. 10 is an example non-limiting diagram illustrating an example of movement correction when the player object 50 present on a lower course path performs a jump action, in a case where two course paths having a height difference are adjacent to each other;

FIG. 11 is an example non-limiting diagram illustrating an example of movement correction when the player object 50 is not in a state of being able to use an item X1 and an effect of the item X1 is not exerted;

FIG. 12 is an example non-limiting diagram illustrating an example of movement correction when the player object 50 is in a state of being able to use the item X1 or in a state of using the item X1;

FIG. 13 is an example non-limiting diagram illustrating an example of steering-wheel correction while the player object 50 is traveling on a single course path;

FIG. 14 is an example non-limiting diagram illustrating steering-wheel correction in a case where a course path splits into two paths;

FIG. 15 is an example non-limiting diagram showing forcible correction when the player object 50 is traveling in a wrong direction;

FIG. 16 is an example non-limiting diagram showing an example of various data stored in a game system 1;

FIG. 17 is an example non-limiting flowchart showing an example of game processing for a racing game;

FIG. 18 is an example non-limiting flowchart showing an example of a player object control process in step S13;

FIG. 19 is an example non-limiting flowchart showing an example of an assist process in step S24;

FIG. 20 is an example non-limiting diagram illustrating a method for calculating a course right end line and a course left end line of a single course path;

FIG. 21 is an example non-limiting diagram illustrating a method for calculating curves at a part splitting into a plurality of course paths;

FIG. 22 is an example non-limiting diagram showing an example when curves at a split point are calculated by the method shown in FIG. 21; and

FIG. 23 is an example non-limiting diagram showing an example when curves at a split point are calculated by the method shown in FIG. 20.

### DETAILED DESCRIPTION OF NON-LIMITING EXAMPLE EMBODIMENTS

### Game System Configuration

A game system according to an example of an exemplary embodiment is described below. FIG. 1 is a diagram showing an exemplary game system. An example of a game system 1 according to the exemplary embodiment includes a main body apparatus (an information processing apparatus; which functions as a game apparatus main body in the exemplary embodiment) 2, a left controller 3, and a right controller 4. The main body apparatus 2 is an apparatus for performing various processes (e.g., game processing) in the game system 1. The left controller 3 and the right controller 4 each include a plurality of direction buttons 30 including an up button, a down button, a right button, and a left button, a plurality of buttons (A button, B button, X button, Y button, L button, R button, etc.), a left analog stick 31, and a right analog stick 35.

Each of the left controller 3 and the right controller 4 is attachable to and detachable from the main body apparatus 2. That is, the game system 1 can be used as a unified apparatus obtained by attaching each of the left controller 3 and the right controller 4 to the main body apparatus 2, or the main body apparatus 2, the left controller 3, and the right controller 4 may be separated from one another, when being used. It should be noted that hereinafter, the left controller 3 and the right controller 4 will occasionally be referred to collectively as a “controller”.

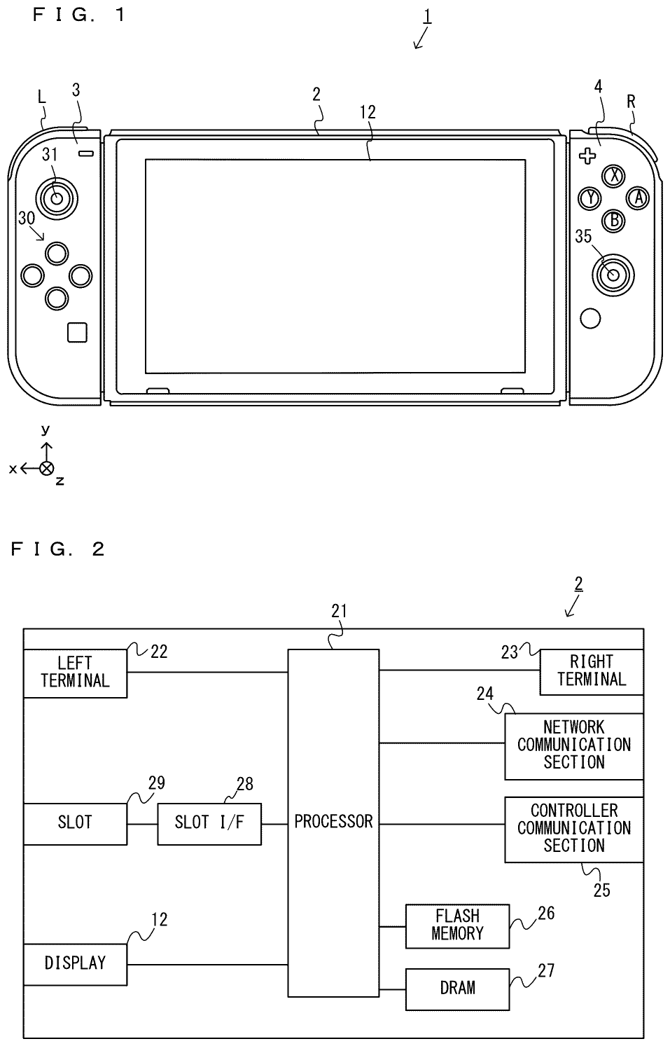

FIG. 2 is a block diagram showing an example of the internal configuration of the main body apparatus 2. As shown in FIG. 2, the main body apparatus 2 includes a processor 21. The processor 21 is an information processing section for executing various types of information processing (e.g., game processing) to be executed by the main body apparatus 2, and for example, includes one of more CPUs (Central Processing Units) and one of more GPUs (Graphics Processing Units). Note that the processor 21 may be configured only by a CPU, or may be configured by a SoC (System-on-a-Chip) that includes a plurality of functions such as a CPU function and a GPU function. The processor 21 executes an information processing program (e.g., a game program) stored in a storage section (specifically, an internal storage medium such as a flash memory 26, an external storage medium attached to the slot 29, or the like), thereby performing the various types of information processing.

Further, the main body apparatus 2 also includes a display 12. The display 12 displays an image generated by the main body apparatus 2. In the exemplary embodiment, the display 12 is a liquid crystal display device (LCD). The display 12, however, may be a display device of any type. The display 12 is connected to the processor 21. The processor 21 displays a generated image (e.g., an image generated by executing the above information processing) and/or an externally acquired image on the display 12.

Further, the main body apparatus 2 includes a left terminal 22, which is a terminal for the main body apparatus 2 to perform wired communication with the left controller 3, and a right terminal 23, which is a terminal for the main body apparatus 2 to perform wired communication with the right controller 4.

Further, the main body apparatus 2 includes a flash memory 26 and a DRAM (Dynamic Random Access Memory) 27 as examples of internal storage media built into the main body apparatus 2. The flash memory 26 and the DRAM 27 are connected to the processor 21. The flash memory 26 is a memory mainly used to store various data (or programs) to be saved in the main body apparatus 2. The DRAM 27 is a memory used to temporarily store various data used for information processing.

The main body apparatus 2 includes a slot 29. The slot 29 is so shaped as to allow a predetermined type of storage medium to be attached to the slot 29. The predetermined type of storage medium is, for example, a dedicated storage medium (e.g., a dedicated memory card) for the game system 1 and an information processing apparatus of the same type as the game system 1. The predetermined type of storage medium is used to store, for example, data (e.g., saved data of a game application or the like) used by the main body apparatus 2 and/or a program (e.g., a game program or the like) executed by the main body apparatus 2.

The main body apparatus 2 includes a slot interface (hereinafter abbreviated as “I/F”) 28. The slot I/F 28 is connected to the processor 21. The slot I/F 28 is connected to the slot 29, and in accordance with an instruction from the processor 21, reads and writes data from and to the predetermined type of storage medium (e.g., a dedicated memory card) attached to the slot 29.

The processor 21 appropriately reads and writes data from and to the flash memory 26, the DRAM 27, and each of the above storage media, thereby performing the above information processing.

The main body apparatus 2 includes a network communication section 24. The network communication section 24 is connected to the processor 21. The network communication section 24 performs wired or wireless communication with an external apparatus via a network. In the exemplary embodiment, as a first communication form, the network communication section 24 connects to a wireless LAN and communicates with an external apparatus, using a method compliant with the Wi-Fi standard. Further, as a second communication form, the network communication section 24 wirelessly communicates with another main body apparatus 2 of the same type, using a predetermined communication method (e.g., communication based on a unique protocol or infrared light communication). It should be noted that the wireless communication in the above second communication form achieves the function of enabling so-called “local communication” in which the main body apparatus 2 can wirelessly communicate with another main body apparatus 2 placed in a closed local network area, and the plurality of main body apparatuses 2 communicate with each other directly or indirectly via an access point to transmit and receive data.

The main body apparatus 2 includes a controller communication section 25. The controller communication section 25 is connected to the processor 21. The controller communication section 25 wirelessly communicates with the left controller 3 and/or the right controller 4. The communication method between the main body apparatus 2 and the left controller 3 and the right controller 4 is optional. In the exemplary embodiment, the controller communication section 25 performs communication compliant with the Bluetooth (registered trademark) standard with the left controller 3 and with the right controller 4.

The processor 21 is connected to the left terminal 22 and the right terminal 23. When performing wired communication with the left controller 3, the processor 21 transmits data to the left controller 3 via the left terminal 22 and also receives operation data from the left controller 3 via the left terminal 22. Further, when performing wired communication with the right controller 4, the processor 21 transmits data to the right controller 4 via the right terminal 23 and also receives operation data from the right controller 4 via the right terminal 23. As described above, in the exemplary embodiment, the main body apparatus 2 can perform both wired communication and wireless communication with each of the left controller 3 and the right controller 4.

It should be noted that, in addition to the elements shown in FIG. 2, the main body apparatus 2 includes a battery that supplies power and an output terminal for outputting images and audio to a display device (e.g., a television) separate from the display 12.

### Outline of Game

Next, the outline of a game executed in the game system 1 will be described. The game in the exemplary embodiment is a racing game in which a player object 50 operated by a player and one or a plurality of opponent objects are subjected to movement control on a course set in a field in a virtual space (game space). The opponent objects may include an object operated by another player and an object automatically controlled by the processor 21.

The player object 50 and one or a plurality of opponent objects travel on a course set in a field, and travel heading toward a goal point on the course. The course is a concept indicating an entire route from a start point to the goal point. The route is an area through which the player object 50 is assumed to move in the field.

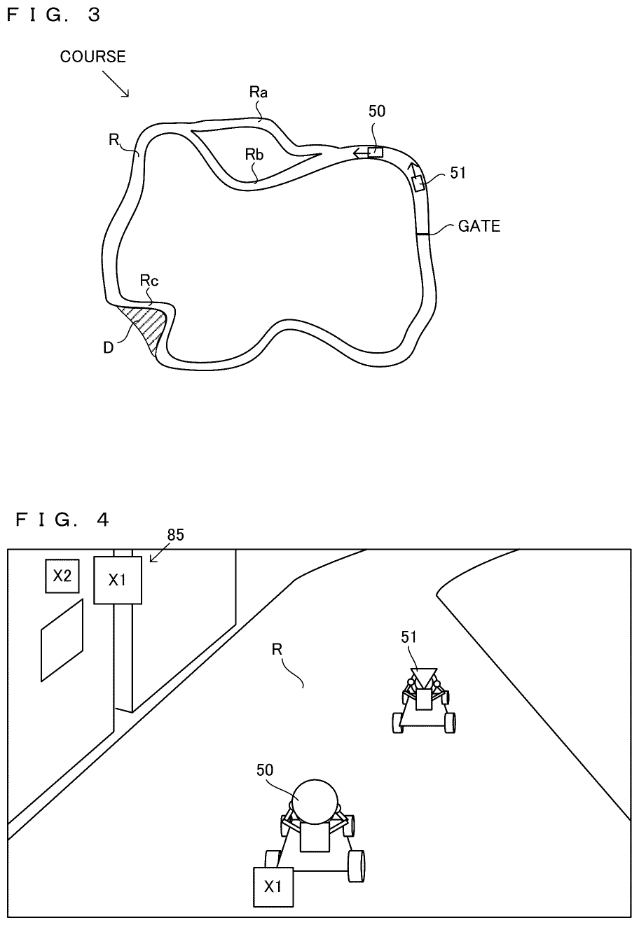

FIG. 3 is a diagram showing an example of a course on which the racing game is performed in the exemplary embodiment. FIG. 4 is a diagram showing an example of a game image displayed on a screen during the racing game.

As shown in FIG. 3, for example, a road R is set in the field, and a gate serving as a start point and a goal point is set. When the racing game is started, the player object 50 and the opponent object 51 start from the start point, and move in advancement directions (arrow directions in FIG. 3) on the course. The player object 50 and the opponent object 51 perform a racing game of, for example, going around a plurality of laps through a route along the road R while heading toward the goal point. The player moves the player object 50 so that the player object 50 will reach the goal point in a higher rank.

The player performs an acceleration operation by pressing the A button, for example. When an acceleration operation is performed, the player object 50 moves forward. The player performs a steering-wheel operation by tilting the left analog stick 31 to the left or the right, for example. When a steering-wheel operation is performed, the movement direction of the player object 50 changes. Specifically, when the left analog stick 31 is tilted in the left-right direction, the orientation of the player object 50 changes in the left-right direction, and the movement direction of the player object 50 changes in the left-right direction. A virtual camera is set at the rear of the player object 50, a game image as viewed from the virtual camera is generated, and the game image as shown in FIG. 4 is displayed on the screen.

In FIG. 4, the player object 50 and the opponent object 51 are displayed, and the depth direction of the screen is the advancement direction on the course. When the player performs an acceleration operation, the player object 50 moves in the depth direction of the screen. When the player tilts the left analog stick 31 leftward, for example, in accordance with the tilt amount, the orientation of the player object 50 changes leftward in the screen and the movement direction thereof changes leftward.

The player object 50 and the opponent object 51 can acquire an item during the racing game and use the acquired item. For example, an item acquisition object that allows acquisition of an item is placed on the course, and when the player object 50 comes into contact with the item acquisition object, one of a plurality of items is given to the player object 50. When the item is used, an effect according to the type of the item is exerted. For example, an item X1 has an effect of temporarily increasing the speed of an object that is using the item X1. For example, when the player object 50 is using the item X1, the speed of the player object 50 temporarily increases. An item X2 has an effect of obstructing traveling of an object other than the object that has used the item X2.

As shown in FIG. 4, the player object 50 possesses the items X1 and X2 and is in a state of being able to use the item X1. At this time, icons indicating the items X1 and X2 are displayed in an item possession area 85, and an icon indicating the item X1 is displayed around the player object 50. In this state, if the player performs a predetermined operation input (e.g., pressing of the L button) for using the item, the player object 50 uses the item X1. When the player object 50 has used the item X1, the player object 50 comes into a state of using the item X1, for a predetermined period, so that the speed of the player object 50 temporarily increases. When the predetermined period has elapsed, the effect of the item X1 is lost, so that the player object 50 comes into a state of not using the item X1. Then, the player object 50 comes into a state of being able to use the item X2. The player object 50 can possess up to two items at the same time, for example.

As shown in FIG. 3, the course in the racing game of the exemplary embodiment has a plurality of course paths, and the player object 50 can pass through various course paths to move to the goal point. Here, the course paths are predetermined areas through which the player object 50 and the opponent object 51 can pass during the racing game. For example, the course has a part splitting into a road Ra which is a course path and a road Rb which is a course path. In addition, the course has a part where a plurality of course paths extend in parallel (not shown).

In addition, the course includes a dirt area D. The dirt area D is an area set on the field, and is an area of lawn, sand, mud, soil, or the like, for example. The dirt area D is an example of a speed reduction field where the speeds of the player object 50 and the opponent object 51 are limited. A course path is also set in the dirt area D, and the player object 50 can travel in the dirt area D during the racing game. Normally, in a case where the player object 50 travels in the dirt area D, the speed of the player object 50 is reduced. In a case where the player object 50 is using the item X1, the speed of the player object 50 is not reduced even when the player object 50 is traveling in the dirt area D. Therefore, the player object 50 can take a shortcut by traveling in the dirt area D using the item X1. In a case where the player object 50 does not possess the item X1, the player object 50 can travel on the road Rc more advantageously than in the dirt area D. Therefore, in a case of not possessing the item X1, the player moves the player object 50 along the road Rc.

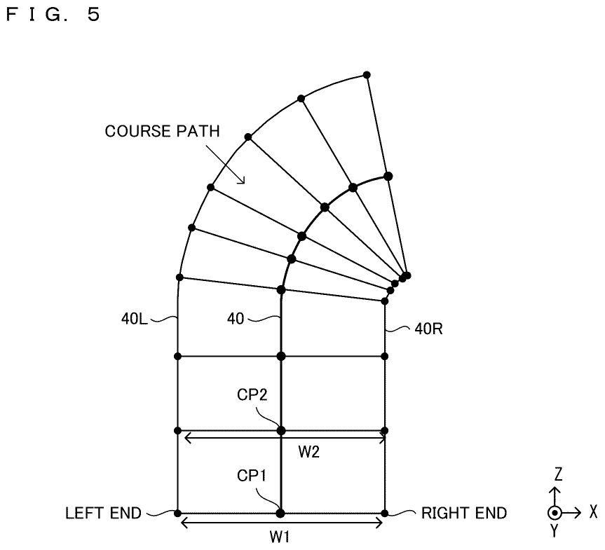

Next, course paths will be described. FIG. 5 shows a part of a course and illustrates a course path. In FIG. 5, a view when a part of the course is seen from above in the virtual space is shown.

As shown in FIG. 5, the course is defined based on a plurality of path points CP (CP1, CP2, . . . ). Each path point CP has coordinate values in an XYZ orthogonal coordinate system, and a width W (W1, W2, . . . ). Specifically, each path point CP has a width Wx in a transverse direction (a direction parallel to an XZ plane), and a width Wy in a height direction (Y-axis direction). In FIG. 5, W1, W2, etc., indicate widths in the transverse direction. Each path point CP has information indicating an order from the start point to the goal point of the course, and information indicating whether or not the path point CP is a split point. In FIG. 5, the advancement direction on the course is a direction from the lower side to the upper side, and the path point CP2 is closer to the goal point than the path point CP1 is.

Both ends in the transverse direction at each path point CP are referred to as “course ends”. Of the two course ends at the path point CP, a course end on the right side with respect to the advancement direction on the course is referred to as “course right end”, and the course end on the left side is referred to as “course left end”.

Connecting the path points CP forms a line 40 passing through the center of the course. Here, the line 40 is referred to as “course center line”. Connecting the course right ends at the path points CP forms a line 40R representing the right end of the course, and connecting the course left ends at the path points CP forms a line 40L representing the left end of the course. Here, the line 40R is referred to as “course right end line”, and the line 40L is referred to as “course left end line”. The course right end line and the course left end line are collectively referred to as “course end lines”.

An area between the course right end line 40R and the course left end line 40L is a course path. The course path has a height and has an upper end and a lower end. The course right end line 40R and the course left end line 40L are actually represented as virtual surfaces. The player object 50 moves through the course path surrounded by the course right end line 40R, the course left end line 40L, the course upper end, and the course lower end. The course right end line 40R and the course left end line 40L are represented by curves (curved surfaces) through an interpolation process described later. A calculation method for the course right end line and the course left end line will be described later.

Typically, each path point CP is set at the center on the road R set in the field. Typically, the width W in the transverse direction at the path point CP is set to the width of the road R set in the field. Such path points CP are set also in areas other than the road in the field. For example, a plurality of path points CP may be set also in areas of lawn, sand, mud, soil, etc., on water, in water, in air, etc., in the field, to define course paths.

The course left end line and the course right end line are internal lines to be used for an assist function, and are not displayed on the screen. Ends of the course displayed on the screen (e.g., both ends of the road R in FIG. 4), and the course left end line and the course right end line, need not exactly coincide with each other, and may be slightly shifted from each other.

### Assist Function

In the game in the exemplary embodiment, a support function is prepared so that even a beginner of the racing game or a player who is not used to the racing game can play comfortably. The player can select ON/OFF of the support function before starting the racing game, for example. The player may select ON/OFF of the support function also during the racing game. Specifically, the support function includes course end movement correction for preventing the player object 50 from going out of the course, and steering-wheel correction for supporting a steering-wheel operation by the player. The course end movement correction is correction performed when the player object 50 comes close to a course end. Hereinafter, the course end movement correction is simply referred to as “movement correction”.

### Movement Correction

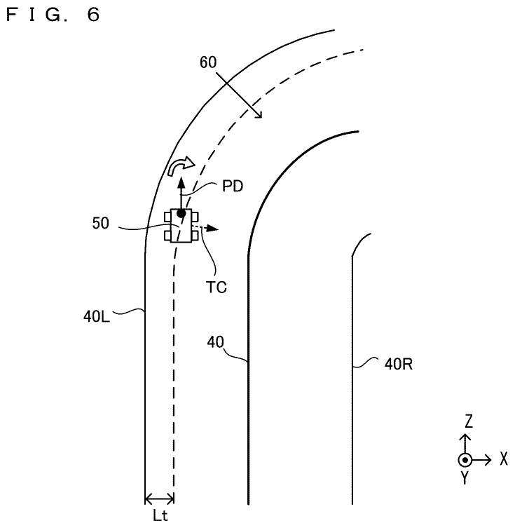

FIG. 6 illustrates movement correction in the assist function in the exemplary embodiment. In FIG. 6, the player object 50 is moving on a course path 60 between the course left end line 40L and the course right end line 40R. PD indicates the movement direction of the player object 50. In a case where the support function is set at ON and the position of the player object 50 satisfies a criterion, movement correction is performed for the player object 50 so that the player object 50 will not go out of the course path. Specifically, for example, when the player object 50 is at a position close to the course left end line 40L (for example, when the player object 50 is within a distance Lt from the course left end line 40L), a movement vector TC in a direction away from the course left end line 40L is applied to the player object 50. For example, the movement vector TC in a direction perpendicular to the course left end line 40L and toward a course center line 40 may be applied to the player object 50.

The amount of the movement vector TC (the length of the movement vector TC) changes in accordance with the distance between the player object 50 and the course left end line 40L. Here, the amount of the movement vector TC applied to the player object 50 is referred to as “movement correction amount”. Specifically, the shorter the distance between the player object 50 and the course left end line 40L is, the greater the movement correction amount is. If the distance between the player object 50 and the course left end line 40L is greater than a threshold Lt, the movement correction amount is zero.

By such movement correction being performed, the player object 50 can be prevented from moving beyond the course left end line 40L. For example, in a case where a wall object as an obstacle is placed along the end of the course, if the support function is set at OFF, the player object 50 collides with the wall object and the speed of the player object 50 is reduced. However, if the support function is set at ON, when the player object 50 comes close to the course left end line 40L, the movement vector TC in a direction away from the course left end line 40L is applied to the player object 50. Thus, the player object 50 can be prevented from colliding with the wall object. In a case where a wall object as an obstacle is not placed along the course end, if the support function is set at OFF, the player object 50 might move beyond the course left end line 40L. The dirt area is set in an area beyond the course left end line 40L, and when the player object 50 moves beyond the course left end line 40L, the speed of the player object 50 is reduced. If the support function is set at ON, the movement correction is performed for the player object 50, so that the player object 50 does not move beyond the course left end line 40L and the course right end line 40R and the speed of the player object 50 can be prevented from being reduced.

As described above, in a case where the assist function is set at ON, movement of the player object 50 is controlled as if walls for preventing the player object 50 from going out of the course path are set on the course left end line 40L and the course right end line 40R of the course path. Here, walls for preventing the player object 50 from going out of the course path may be referred to as “assist walls”. The course left end line 40L and the course right end line 40R serve as the assist walls.

When the player object 50 and the course end line are close to each other, the movement correction is performed and rotation correction for imparting rotation to the player object 50 is performed. For example, rotation is imparted to the player object 50 so that the movement direction PD of the player object 50 becomes close to a direction parallel to the course end line. For example, in the case shown in FIG. 6, rightward rotation (clockwise rotation) is imparted to the player object 50. The shorter the distance between the player object 50 and the course end line is, the greater the imparted rotation is. Thus, it becomes easy for the player object 50 to move in a direction along the course.

As described above, in a case where the assist function is set at ON, movement correction in a direction away from the end of the course path and rotation correction are performed for the player object 50, based on the positional relationship between the position of the player object 50 and the end of the course path.

Here, movement correction in a case where a plurality of course paths are present will be described. As described above, the course in the exemplary embodiment has a plurality of course paths. For example, the course has a part splitting into a plurality of course paths and a part where a plurality of course paths extend in parallel. In the following description, the assist function in a case where the player object 50 passes through an area having a plurality of course paths will be described.

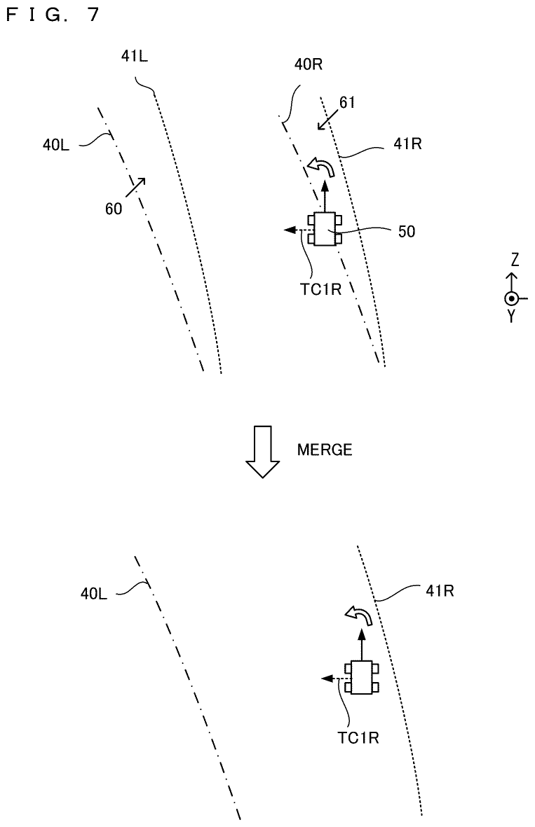

Each of the plurality of course paths has a plurality of path points CP, and the width W in the left-right direction is set for each path point CP. Based on these data, a course left end line and a course right end line are calculated for each of the plurality of course paths. FIG. 7 illustrates movement correction in a case where two course paths overlap each other.

In FIG. 7, a course path 60 between the course left end line 40L and the course right end line 40R, and a course path 61 between a course left end line 41L and a course right end line 41R, are shown. As shown in FIG. 7, the two course paths have overlapping parts, and the position of the player object 50 is included in each of the two course paths. In a case where the assist function is set at ON, movement vectors based on ends of the plurality of course paths are each calculated, and among these movement vectors, the smallest movement vector is applied to the player object 50.

For example, in FIG. 7, the course right end line 40R is on the inner side of the course right end line 41R, and the distance between the player object 50 and the course right end line 41R is longer than the distance between the player object 50 and the course right end line 40R. Therefore, a movement correction amount based on the course right end line 41R is smaller than a movement correction amount based on the course right end line 40R. Thus, a movement vector TC1R based on the course left end line 41R is applied to the player object 50. The course left end line 41L is on the inner side of the course left end line 40L, and the distance between the player object 50 and the course left end line 40L is longer than the distance between the player object 50 and the course left end line 41L. Therefore, the course left end line 40L is used in movement correction for the player object 50. In FIG. 7, since the player object 50 is sufficiently distant from the course left end line 40L, the movement correction amount based on the course left end line 40L is zero.

As described above, in the exemplary embodiment, in a case where the position of the player object 50 is included in two course paths, the two course paths are substantially merged, and movement correction is performed based on the ends of the merged course path. Also in a case where there are three or more course paths through which the player object 50 can pass, movement vectors based on the ends of the course paths are calculated, and the smallest movement vector is applied to the player object 50. The same applies to the rotation correction.

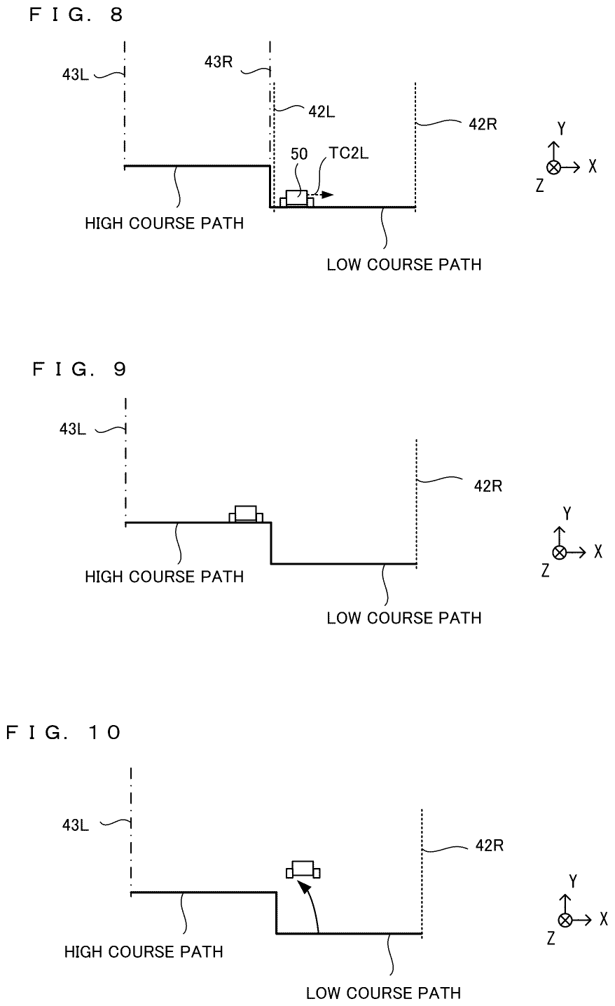

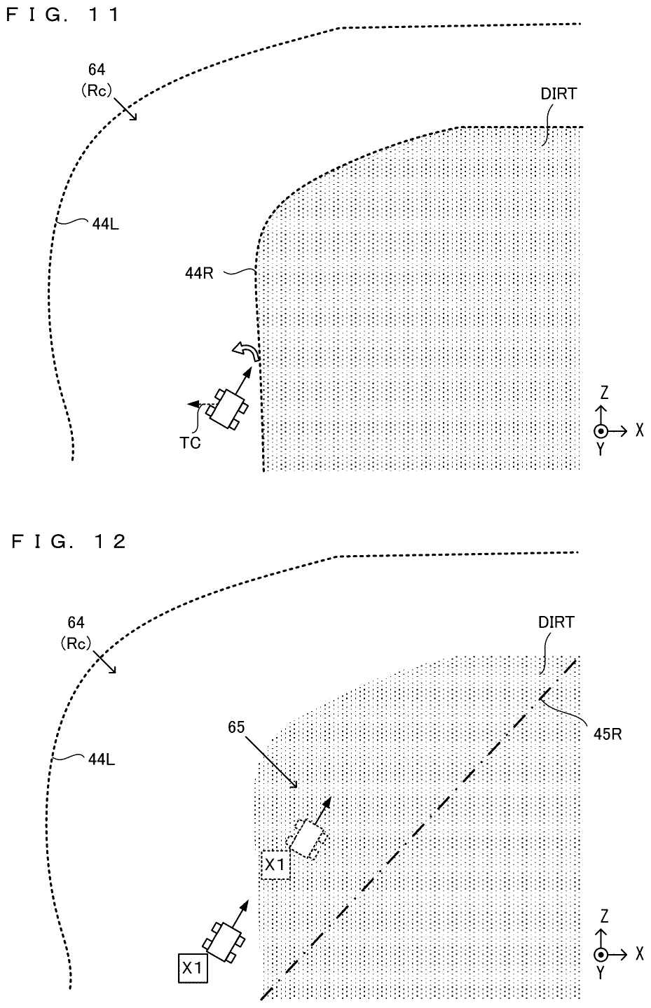

Next, movement correction in a case where a plurality of course paths different in height are adjacent to each other will be described. FIG. 8 illustrates an example of movement correction when the player object 50 is present on a lower course path in a case where two course paths having a height difference are adjacent to each other. FIG. 9 illustrates an example of movement correction when the player object 50 is present on a higher course path in a case where two course paths having a height difference are adjacent to each other. FIG. 10 illustrates an example of movement correction when the player object 50 present on a lower course path performs a jump action in a case where two course paths having a height difference are adjacent to each other. In FIG. 8 to FIG. 10, the depth directions of the drawing sheets are the advancement direction on the course, and the up direction in each drawing indicates the height direction in the virtual space.

As shown in FIG. 8, a course path set at a high position and a course path set at a low position in the virtual space are adjacent to each other. The low course path is a course path between a course left end line 42L and a course right end line 42R. The high course path is a course path between a course left end line 43L and a course right end line 43R. As described above, a width in the height direction is also set for each path point, but in FIG. 8 to FIG. 10, lines indicating ends in the height direction are not shown.

As shown in FIG. 8, in a case where the player object 50 is present in the low course path and the position of the player object 50 is lower than the height of the lower end of the high course path, the course left end line 42L serves as an assist wall. Therefore, when the player object 50 is at a position close to the course left end line 42L, a movement vector TC2L based on the course left end line 42L is applied to the player object 50. The course right end line 42R also serves as an assist wall, and when the player object 50 is at a position close to the course right end line 42R, movement based on the course right end line 42R is applied to the player object 50.

On the other hand, as shown in FIG. 9, in a case where the player object 50 is present in the high course path, the course left end line 42L and the course right end line 43R as assist walls are disabled. That is, of the high course path and the low course path adjacent to each other, the course right end line 42R of the low course path and the course left end line 43L of the high course path serve as assist walls. Therefore, even in a case where the player object 50 is present at a position close to the right end in the high course path, movement based on the course right end line 43R is not applied to the player object 50. Thus, even when the assist function is ON, the player object 50 can move from the high course path to the low course path. In a case where the player object 50 is at a position close to the left end in the high course path, movement based on the course left end line 43L is applied to the player object 50.

As shown in FIG. 10, in a case where the player object 50 is present in the low course path and the position of the player object 50 is higher than the height of the lower end of the high course path, the course left end line 42L and the course right end line 43R as assist walls are disabled. That is, of the high course path and the low course path adjacent to each other, the course right end line 42R of the low course path and the course left end line 43L of the high course path serve as assist walls. For example, the player object 50 can perform a jump action based on a player's operation. In a case where a jump action is performed when the player object 50 is present in the low course path, the position of the player object 50 can become higher than the height of the lower end of the high course path. In this case, even when the player object 50 is at a position close to the left end in the low course path, movement based on the course right end line 43R is not applied to the player object 50. Therefore, even when the assist function is ON, the player object 50 can move from the low course path to the high course path by performing a jump action, for example.

As described above, two course paths are merged or not merged, depending on the state of the player object 50 (whether or not the player object 50 is at a position higher than the adjacent course path).

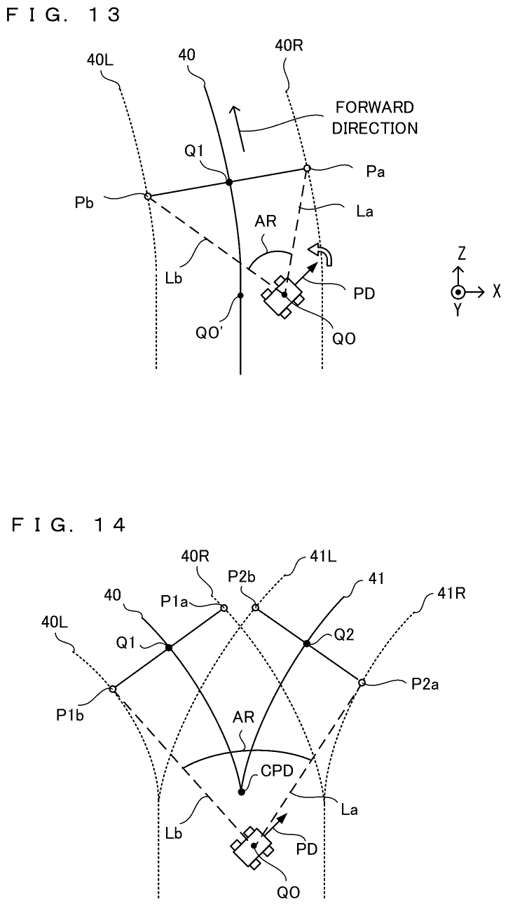

Next, movement correction according to the item possession state of the player object 50 will be described. FIG. 11 illustrates an example of movement correction when the player object 50 is not in a state of being able to use the item X1 and the effect of the item X1 is not exerted. FIG. 12 illustrates an example of movement correction when the player object 50 is in a state of being able to use the item X1 or in a state of using the item X1.

As shown in FIG. 11, a course path 64 between the course right end line 44R and the course left end line 44L is set, and the player object 50 is traveling on the course path 64. The course path 64 is set along the road Rc, for example. A dirt area is set on the right side of a course right end line 44R of the course path 64. In FIG. 11, the assist function is set at ON, and the player object 50 is in a state of being unable to use the item X1. That is, this state is a state in which the player object 50 does not possess the item X1, or a state in which the player object 50 possesses the item X1 but the item X1 is possessed as an item to be used second. In FIG. 11, the player object 50 is in a state of not using the item X1. In this state, if the player object 50 comes close to the course right end line 44R, a movement vector TC based on the course right end line 44R is applied to the player object 50. In addition, rotation correction is also applied in the same manner as described above. Therefore, in a case where the assist function is set at ON, the player object 50 does not go out of the course path on which the player object 50 is traveling, and does not move into the dirt area.

On the other hand, as shown in FIG. 12, in a case where the player object 50 is in a state of being able to use the item X1 or in a case where the player object 50 is using the item X1, even if the assist function is set at ON, the player object 50 can move into the dirt area. Specifically, a course path 65 is set in advance on the dirt area. The course path 65 on the dirt area is a course path between a course right end line 45R and a course left end line 45L (the course left end line 45L is not shown). In a case where the player object 50 is in a state of being able to use the item X1, the course right end line 45R corresponding to the course path 65 serves as an assist wall on the right side and the course left end line 44L corresponding to the course path 64 serves as an assist wall on the left side. That is, in a case where the player object 50 is in a state of being able to use the item X1, movement correction is performed based on the course left end line 44L on the left side of the course path 64 and the course right end line 45R on the right side of the course path 65, of the course path 64 and the course path 65. In other words, in a case where the player object 50 is in a state of being able to use the item X1, the course right end line 44R of the course path 64 where the player object 50 is present does not serve as an assist wall and is disabled. Therefore, in a case where the player object 50 is in a state of being able to use the item X1, the player object 50 can move into the dirt area from the course path 64. The same applies to a case where the player object 50 is using the item X1. As described above, the item X1 has an effect of temporarily increasing the speed of the player object 50 that is using the item X1, and preventing the speed from being reduced even when the player object 50 has moved into a dirt area. Therefore, it is possible to use the item X1 while intentionally moving into a dirt area in order to take a shortcut through a curve part, for example. Other than the case of the item X1, also in a case where the player object 50 is in a state of being able to use an item (an item for disabling the speed reduction effect of a dirt area) having an effect equivalent to the item X1 or in a case where the player object 50 is using this item, the above applies in the same manner.

While the player object 50 is present in the course path 65 set on the dirt area, the same state as in the state in which the player object 50 is able to use the item X1 or the state in which the player object 50 is using the item X1 is maintained. That is, as shown in FIG. 12, the course right end line 44R of the course path 64 is maintained in a state of being disabled. Therefore, for example, even in a case where the effect of the item X1 is lost after the player object 50 uses the item X1 and moves into the dirt area, the player object 50 can continue traveling in the dirt area. In this case, the speed of the player object 50 is reduced.

As described above, in a case where the assist function is set at ON, movement correction is performed based on the positional relationship between the player object 50 and one of the ends of one or a plurality of course paths. In a case where there are a plurality of course paths, the plurality of course paths are merged in accordance with the state of the player object 50, to perform movement correction. Specifically, when the player object 50 is in a first state, movement correction is performed based on an end on one side of a course path that is on the one side and an end on another side of a course path that is on the other side, among the plurality of course paths. When the player object 50 is in a second state, movement correction is performed based on both ends of one course path in which the position of the player object 50 is included, among the plurality of course paths. The first state may be a state in which the position of the player object 50 is included in each of the plurality of course paths, for example. The first state may be a state in which the height of the lower end of the course path in which the position of the player object 50 is not included is equal to or smaller than the height of the position of the player object 50, and the second state may be a state in which the height of the lower end of the course path in which the position of the player object 50 is not included is greater than the height of the position of the player object 50. In a case where a high course path and a low course path are adjacent to each other, the first state may be a state in which the player object 50 is present in the high course path, and the second state may be a state in which the player object 50 is present in the low course path. In a state in which the player object 50 is present in the low course path, the player object 50 may come into the first state from the second state in accordance with a jump action. The first state may be a state in which the player object 50 is able to use a predetermined item or a state in which the player object 50 is using a predetermined item.

The state of the player object 50 may be determined in accordance with the type of the course path in which the position of the player object 50 is included. For example, in a case where the player object 50 is present in a course path of a first type (e.g., an area of mud or soil), the state of the player object 50 may be the first state and a plurality of course paths may be merged. On the other hand, in a case where the player object 50 is present in a course path of a second type, the state of the player object 50 may be the second state and movement correction may be performed based on both ends of one of a plurality of course paths.

### Steering-Wheel Correction

Next, steering-wheel correction will be described. In the exemplary embodiment, in a case where the assist function is set at ON, steering-wheel correction for supporting a steering-wheel operation by the player is performed in addition to movement correction and rotation correction based on the course end lines (assist walls) described above. First, control for the movement direction of the player object 50 based on a direction operation input from the player in a case where steering-wheel correction is not performed will be described.

For example, in a case where the player tilts the left analog stick 31 in the left-right direction, a value of “−1” to “1” is acquired as an input amount. “−1” is a value acquired when the left analog stick 31 is maximally tilted leftward, for example. “1” is a value acquired when the left analog stick 31 is maximally tilted rightward, for example. “0” is a value acquired when the left analog stick 31 is not tilted in the left-right direction (is in a neutral state). A value of “−1” to “1” is acquired in accordance with the tilt amount when the left analog stick 31 is tilted in the left-right direction. For example, in a case where the left analog stick 31 is tilted leftward by half the maximum value, “−0.5” is acquired as an input amount.

In a case where steering-wheel correction is not performed, the movement direction of the player object 50 is controlled based on the input amount acquired in accordance with tilt in the left-right direction of the left analog stick 31. For example, in a case where an input of “−1” as the input amount has continued for about 1 second, the movement direction of the player object 50 is controlled so as to be about 45 degrees leftward with respect to the front direction set at 0 degrees. As another example, in a case where an input of “1” as the input amount has continued for about 1 second, the movement direction of the player object 50 is controlled so as to be about 45 degrees rightward.

In a case where the assist function is set at ON, if a correction condition is satisfied, the input amount acquired in accordance with tilt in the left-right direction of the left analog stick 31 is corrected. FIG. 13 illustrates an example of steering-wheel correction when the player object 50 is traveling on a single course path.

As shown in FIG. 13, it is assumed that the player object 50 is traveling on a course path between the course right end line 40R and the course left end line 40L. The position of the player object 50 is “Q0”, and the movement direction of the player object 50 is “PD”. In this case, positions Pa and Pb of both ends of the course path at a position Q1 advanced by a certain distance in the advancement direction on the course path from the position Q0 of the player object 50 are calculated. For example, a position (Q0′) of the player object 50 on the course center line 40 is calculated based on the ratio of distances of the last path point through which the player object 50 has passed, the position Q0 of the player object 50, and the next path point. The point Q1 advanced along the course center line 40 by a certain distance from the position Q0′ of the player object 50 on the course center line 40 is calculated. Next, positions of both ends in the width direction at Q1 are calculated as Pa and Pb. Specifically, Pa which is an intersection of the course right end line 40R and a straight line passing through the position Q1 and perpendicular to the course center line 40, is calculated. In addition, Pb which is an intersection of the course left end line 40L and a straight line passing through the position Q1 and perpendicular to the course center line 40, is calculated. Then, whether or not the movement direction PD of the player object 50 is within a range between a straight line La (first direction) extending from Q0 to Pa and a straight line Lb (second direction) extending from Q0 to Pb, is determined. Here, the range between the two straight lines La and Lb is referred to as “appropriate range AR”. In a case where the movement direction PD is within the appropriate range AR, steering-wheel correction is not performed.

As shown in FIG. 13, in a case where the movement direction PD is not within the appropriate range AR, steering-wheel correction is performed so that the movement direction PD becomes close to a direction within the appropriate range AR. Specifically, a steering-wheel correction value is calculated, and steering-wheel correction is performed to apply correction based on the steering-wheel correction value to the input amount acquired in accordance with tilt in the left-right direction of the left analog stick 31.

Specifically, steering-wheel correction is performed so that the movement direction PD becomes close to a direction that is closer to the movement direction PD before correction, of the direction of La and the direction of Lb of the appropriate range AR. For example, in the case shown in FIG. 13, the movement direction PD before correction is directed rightward relative to the straight line La of the appropriate range AR. Therefore, a steering-wheel correction value is calculated so as to bring the movement direction PD close to the direction of the straight line La. As the steering-wheel correction value, a negative value (−1 to 0) indicating the left direction is calculated. The greater the angle between the movement direction PD and the straight line La is, the greater the absolute value of the calculated steering-wheel correction value is. On the other hand, in a case where the movement direction PD is directed leftward relative to the straight line Lb of the appropriate range AR, a positive value (0 to 1) indicating the right direction is calculated as the steering-wheel correction value. For correction, a method in which a corrected input amount is determined in consideration of both of the acquired input amount and the steering-wheel correction value, is used. For example, in a case where the signs of the acquired input amount and the steering-wheel correction value are equal to each other, the one having the greater absolute value, of the acquired input amount and the steering-wheel correction value, can be used as a corrected input amount. On the other hand, in a case where the signs of the acquired input amount and the steering-wheel correction value are different from each other, for example, in a range to a maximum input amount (e.g., −1.0 or 1.0) in the opposite direction from the steering-wheel correction value, a value obtained through linear interpolation of the range at a ratio according to the absolute value of the acquired input amount can be used as a corrected input amount. Through such correction, the movement direction PD can easily become close to the direction of the straight line La within such a range that the feeling of strangeness is small with respect to the original input. As another example of correction, a steering-wheel correction amount as a difference for applying correction may be calculated, and the steering-wheel correction amount may be added to the acquired input amount.

In the above description, the position Q0′ of the player object 50 on the course center line 40 is calculated, and the position Q1 on the course center line 40 advanced by a certain distance from the position Q0′ is calculated. In another exemplary embodiment, without calculating the position Q0′ on the course center line 40, a position on the course path advanced by a certain distance from the position Q0 of the player object 50 may be calculated, and both ends at the advanced position may be calculated as Pa and Pb.

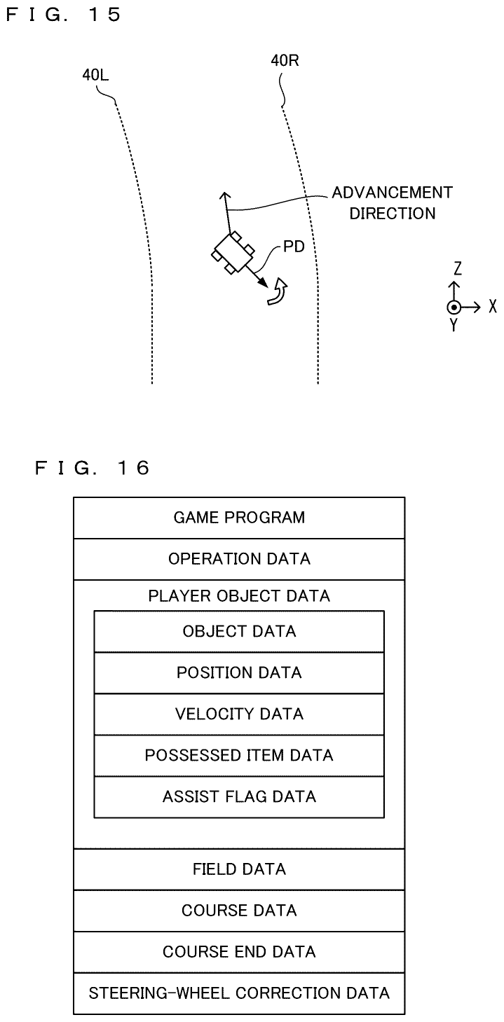

Next, steering-wheel correction at a part splitting into a plurality of course paths will be described. FIG. 14 illustrates steering-wheel correction in a case where a course path splits into a plurality of paths.

As shown in FIG. 14, it is assumed that the player object 50 is traveling at a position before a path point CPD which is a split point. The position of the player object 50 is “Q0”, and the movement direction of the player object 50 is “PD”. The course path splits into a left course path and a right course path with the path point CPD as a split point. The left course path is a course path between the course right end line 40R and the course left end line 40L, and the right course path is a course path between the course right end line 41R and the course left end line 41L. The line 40 represents the course center line of the left course path, and a line 41 represents the course center line of the right course path.

In this case, positions P1a and P1b of both ends of the left course path at the position Q1 advanced by a certain distance in the advancement direction on the left course path from the position Q0 of the player object 50, are calculated. In addition, positions P2a and P2b of both ends of the right course path at the position Q2 advanced by a certain distance in the advancement direction on the right course path from the position Q0, are calculated. P2a is a point on the course right end line 41R of the right course path, and P1b is a point on the course left end line 40L of the left course path. Next, a straight line La (first direction) extending from Q0 to P2a and a straight line Lb (second direction) extending from Q0 to P1b are calculated. Then, whether or not the movement direction PD of the player object 50 is within the appropriate range AR between the straight line La and the straight line Lb, is determined. In the example shown in FIG. 14, since the movement direction PD is not within the appropriate range AR, steering-wheel correction is performed. A method for the steering-wheel correction is the same as described above.

As described above, the input amount acquired in accordance with tilt in the left-right direction of the left analog stick 31 is corrected, whereby the player object 50 can be easily directed toward the advancement direction on the course path. In addition, without directly changing the movement direction PD of the player object 50, the input amount is corrected, whereby it is possible to correct the movement direction PD of the player object 50 to an appropriate direction while reflecting a steering-wheel operation by the player.

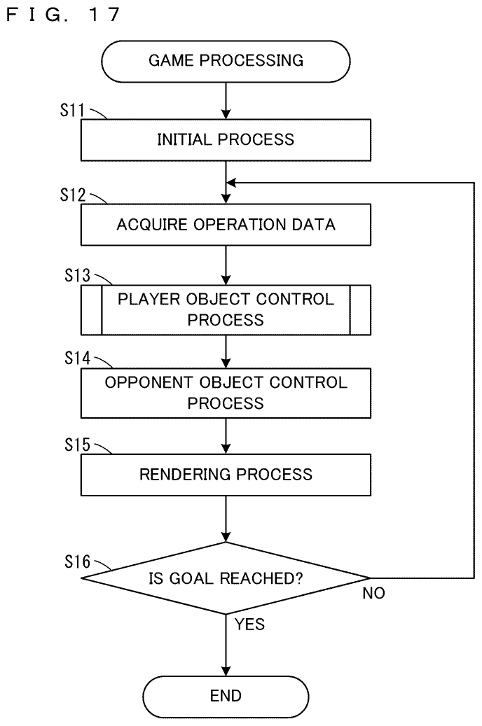

In a case where an angle between the movement direction PD of the player object 50 and the advancement direction of the course path is equal to or greater than a certain value, the movement direction PD is subjected to forcible correction so as to be directed toward the advancement direction. For example, in a case where the movement direction PD of the player object 50 is opposite to the advancement direction, the forcible correction is performed. FIG. 15 shows forcible correction when the player object 50 is traveling in a wrong direction.

As shown in FIG. 15, in a case where the movement direction PD of the player object 50 is opposite to the advancement direction (the angle between the movement direction PD and the advancement direction is greater than 90 degrees), forcible correction for directing the movement direction PD toward the advancement direction is performed. The forcible correction is performed so that the angle between the movement direction PD and the advancement direction becomes small. For example, correction may be performed so as to forcibly overwrite the input amount to “1” which is the maximum input amount in the right direction or “−1” which is the maximum input amount in the left direction. Alternatively, the movement direction PD of the player object 50 may be forcibly changed.

Through such forcible correction, it is possible to prevent wrong-direction traveling of the player object 50 which cannot be corrected by only the movement correction and the steering-wheel correction described above.

As described above, in a case where the assist function is set at ON, both ends at a position on a course path advanced by a predetermined distance along the course path from a position (Q0) of the player object 50 during movement are defined as a first position and a second position, and if the movement direction of the player object is not included between a first direction (the direction of La) toward the first position from the position during the movement and a second direction (the direction of Lb) toward the second position from the position during the movement, the input amount is corrected so that the movement direction becomes close to a third direction included at least between the first direction and the second direction. The third direction is a direction closer to the movement direction before correction, of the first direction and the second direction. Thus, the input amount can be corrected so that the player object 50 moves toward the position advanced by the predetermined distance along the course path, whereby it is possible to perform correction for the movement direction of the player object 50 appropriately even in a case where the width of the course is great.

For example, it is conceivable that the input amount acquired in accordance with tilt in the left-right direction of the left analog stick 31 is corrected when the player object 50 comes close to a course end to a certain extent. In this case, correction is not performed until the player object 50 comes close to a course end to a certain extent, and therefore there is a possibility that the player object 50 takes a long way in a course having a great width, for example. However, in the exemplary embodiment, in a case where the movement direction of the player object 50 is not included between the first direction and the second direction, steering-wheel correction is performed. Thus, correction can be performed by the time when the player object 50 comes close to a course end and it is possible to perform correction appropriately without taking a long way even in a course having a great width.

In a case where the position on the course path advanced by the predetermined distance along the course path from the position of the player object 50 during the movement is a part splitting into a plurality of course paths, an end on one side of a course path that is on the one side is set as the first position and an end on another side of the course path that is on the other side is set as the second position, to calculate the first direction and the second direction. Thus, even at a part splitting into a plurality of course paths, it is possible to correct the input amount appropriately. When the player object 50 is traveling at a position before the split point, it is possible to guide the player object 50 into a range including the plurality of course paths instead of guiding the player object 50 into one of the plurality of course paths.

In a case where the movement direction of the player object 50 is deviated from the advancement direction on the course path by a predetermined criterion or more, the input amount is corrected so that the movement direction of the player object 50 becomes close to the advancement direction on the course path. Thus, it is possible to prevent the player object 50 from traveling in a wrong direction, for example.

### Details of Game Processing

Next, the details of the game processing in the game system 1 will be described.

FIG. 16 shows an example of various data stored in the game system 1. As shown in FIG. 16, a game program, operation data, player object data, field data, course data, course end data, and steering-wheel correction data are stored in a memory (e.g., the DRAM 27, the storage medium attached to the slot 29, or the flash memory 26) of the game system 1.

The game program is a program for executing the game processing in the exemplary embodiment. The game program is stored in the storage medium attached to the slot 29 or the flash memory 26 in advance, and is loaded into the DRAM 27 when the game is executed.

The operation data is data according to a player's operation, transmitted from the controllers 3 and 4, for example. The operation data includes data indicating an input amount according to tilt in the left-right direction of the left analog stick 31, data indicating whether or not each button is operated, and the like, for example. The operation data is transmitted from the controller to the main body apparatus 2 at predetermined time intervals (e.g., intervals of 1/200 s).

The player object data is data about the player object 50 controlled by a player. The player object data includes object data representing the shape and the outer appearance of the player object 50, position data representing the position of the player object 50, and velocity data representing the speed and the movement direction (orientation) of the player object 50. Further, the player object data includes possessed item data indicating information about an item possessed by the player object 50, and assist flag data indicating whether or not the assist function is ON.

The field data is data representing a field in a virtual space, and data representing a terrain. The field data includes data representing types, shapes, outer appearances, and the like of terrains. In a field, an object representing a road, objects representing dirt areas such as grass, lawn, sand, soil, and mud areas, and objects representing a wall, a building, and the like, are set.

The course data is data stored in advance, and is data defining a course from a start point to a goal point where a racing game is performed. The course in the racing game in the exemplary embodiment includes a plurality of course paths. The course data includes course path data representing each of the plurality of course paths. The course path data includes a plurality of path points CP. Each path point CP includes a width in the transverse direction, a width in the height direction, an order, and the like. Based on the plurality of path points and the width in the transverse direction at each path point, both ends of the course path are determined and the course path is defined. In another exemplary embodiment, as the course path data, data indicating both ends of the course path may be stored or data indicating one end of the course path and the width thereof may be stored. As the course path data, data representing the center line and the width of the course path may be stored.

The course end data is data representing the course left end line and the course right end line, and is data representing assist walls. The course left end line and the course right end line are represented by curves (curved surfaces). The course end data is generated based on the course data at the start of the racing game or during the racing game. The course end data may be generated based on the course data in advance and then stored in the memory.

The steering-wheel correction data is data indicating the steering-wheel correction value. The steering-wheel correction value can take a value of −1 to 1, for example. In a case where the steering-wheel correction value is a negative value, steering-wheel correction for allowing the input amount to be easily directed leftward is performed, and in a case where the steering-wheel correction value is positive, steering-wheel correction for allowing the input amount to be easily directed rightward is performed.

Besides the above data, various data are stored in the memory. For example, data about an opponent object (data representing the outer appearance, the position, the speed, the item possession state, and the like) are stored.

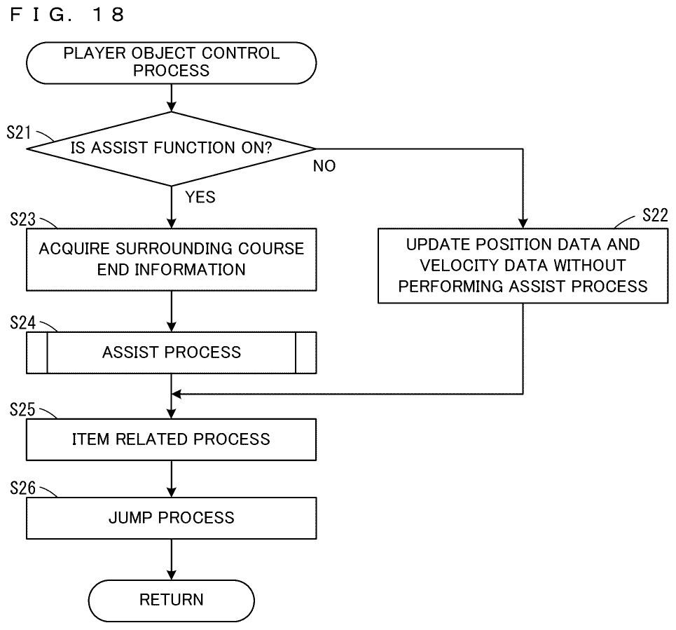

Next, the game processing performed in the game system 1 will be described. FIG. 17 is a flowchart showing an example of the game processing for the racing game. The game processing is started when an instruction for starting the racing game is performed by a player. In FIG. 17, processes relevant to the assist function described above are mainly described, and description of other processes is omitted.

In the exemplary embodiment, the processor 21 of the main body apparatus 2 executes the above game program using the memory, thereby executing a process in each step shown in FIG. 17 to FIG. 19. However, in another exemplary embodiment, some of processes in the respective steps may be executed by a processor (e.g., a dedicated circuit) other than the processor 21. In a case where the game system 1 is communicable with another information processing apparatus (e.g., server), some of the processes in the respective steps may be executed on the other information processing apparatus. The processes in the respective steps are merely examples. As long as the same result is obtained, the processing order of the steps may be changed or another process may be executed in addition to (or instead of) the process in each step.

As shown in FIG. 17, first, the processor 21 performs an initial process (step S11). Here, the processor 21 sets one of a plurality of courses, based on a player's selection operation, and places the player object 50 and a plurality of opponent objects at a start point of the set course. In addition, the processor 21 sets ON/OFF of the assist function, based on a player's operation. For example, as a default, the assist function is set at OFF, and in the initial process, the assist function is set at ON based on a player's operation. When the assist function is set at ON, a value indicating ON is stored in the assist flag data. When the initial process is finished, the processor 21 starts the racing game and executes processes in the next step S12 and subsequent steps.

When the racing game is started, the processor 21 acquires operation data from the controllers 3 and 4 (step S12). The processor 21 hereafter executes the processes in steps S12 to S16 repeatedly at predetermined frame time intervals (e.g., intervals of 1/60 s). While the processes in steps S12 to S16 are repeatedly executed, the racing game may be paused and ON/OFF of the assist function may be switched, based on a player's operation.

Next, the processor 21 executes a player object control process (step S13). Here, based on the operation data, the processor 21 updates the position, the speed, the movement direction, the item possession state, and the like of the player object 50. In addition, the processor 21 causes the player object 50 to perform a jump action or use an item, based on the operation data. In addition, in a case where the assist function is set at ON, the processor 21 performs an assist process. Hereinafter, the details of the player object control process will be described.

### Player Object Control Process

FIG. 18 is a flowchart showing an example of the player object control process in step S13.

As shown in FIG. 18, the processor 21 determines whether or not the assist function is set at ON, based on the assist flag data (step S21). For example, in the initial process, the assist function is set at ON based on a player's operation before start of the racing game. After the racing game is started, the racing game may be paused and ON/OFF of the assist function may be switched, based on a player's operation.

If the assist function is not set at ON (step S21: NO), the processor updates the position data and the velocity data of the player object 50 without performing the assist process (step S22). Here, the processor 21 updates the speed of the player object 50 in accordance with whether or not an acceleration operation is performed, updates the movement direction of the player object 50 in accordance with an input amount according to tilt in the left-right direction of the left analog stick 31, and updates the position of the player object 50 in accordance with the speed and the movement direction.

On the other hand, if the assist function is set at ON (step S21: YES), the processor 21 acquires course end information around the player object 50 (step S23). Here, as the course end information, curves (course right end line and course left end line) representing course ends around the player object 50 are acquired. Specifically, in step S23, a course right end line and a course left end line present around the player object 50 are calculated based on the course data (data indicating a plurality of path points CP and widths at respective path points). The calculated data indicating the course right end line and the course left end line are stored as course end data in the memory. Data about curves representing course ends, calculated based on course data, may be stored in the memory in advance, and in step S23, the data stored in the memory may be read, to acquire course end information. Hereinafter, a calculation method for curves representing course ends will be described.

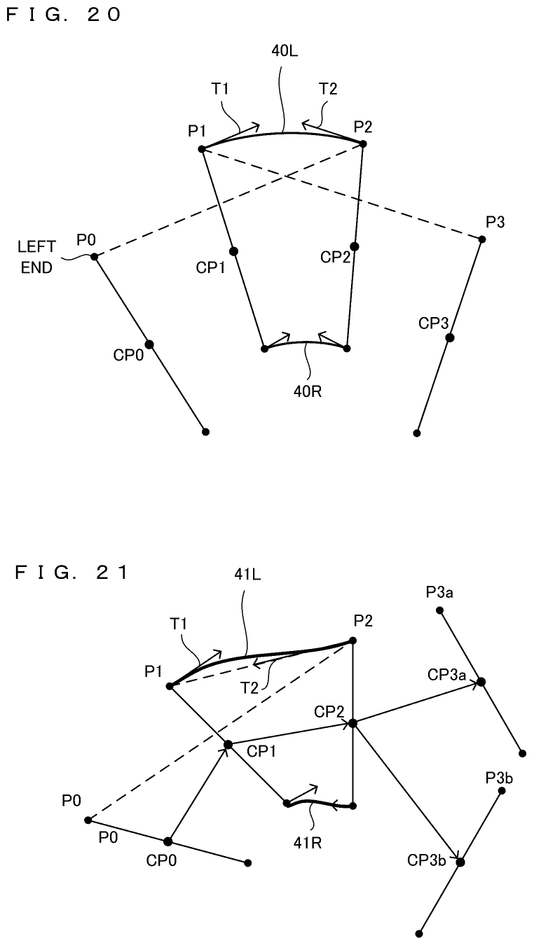

FIG. 20 illustrates a method for calculating a course right end line and a course left end line of a single course path.

The course right end line and the course left end line are calculated by interpolation based on both ends at respective path points CP. As an interpolation method, for example, Bezier interpolation is used. CP0 to CP3 shown in FIG. 20 are path points, and a direction from CP0 toward CP3 is the advancement direction on the course path. P0 to P3 are course left ends at the respective path points CP0 to 3. In FIG. 20, a method for calculating a curve 40L connecting P1 and P2 is shown.

As shown in FIG. 20, in a case of calculating the curve 40L connecting P1 and P2, preceding and subsequent end points P0 and P3 are used. Specifically, a tangent T parallel to a straight line connecting preceding and subsequent end points with respect to one end point is calculated. For example, a straight line connecting P0 and P2 is calculated, and a tangent T1 parallel to the straight line and having a tangent point at P1 is calculated. Similarly, a straight line connecting P1 and P3 is calculated, and a tangent T2 parallel to the straight line and having a tangent point at P2 is calculated. Then, a Bezier curve is calculated based on the calculated tangents T1 and T2.

A curve 40R on the right side is also calculated by the same method. That is, with respect to an end point (course right end) on the right side, a tangent parallel to a straight line connecting preceding and subsequent end points is calculated. Then, the curve 40R is calculated based on two calculated tangents.

FIG. 21 illustrates a method for calculating curves at a part splitting into a plurality of course paths.

As shown in FIG. 21, path points CP0 to CP2 represent a single course path, and the course path splits into two course paths from the path point CP2 as a split point. In FIG. 21, a method for calculating a curve 41L connecting a left end P2 at the split point CP2 and a left end P1 at the immediate preceding path point CP1 is shown. Specifically, for the left end P1 at the path point CP1 which is not the split point, in the same manner as described above, a tangent T1 parallel to a straight line connecting the preceding and subsequent left ends P0 and P2 is calculated. On the other hand, for the left end P2 at the split point CP2, a straight line connecting P2 and the immediate preceding point P1 is calculated and a tangent T2 parallel to the straight line is calculated. Then, a Bezier curve is calculated based on the calculated tangents T1 and T2. A curve 41R on the right side is also calculated by the same method.

As described above, for the split point CP2, a Bezier curve is calculated based on a tangent parallel to a straight line connecting the end point P2 at the split point and the immediate preceding end point P1. On the other hand, for a path point that is not a split point, a Bezier curve is calculated based on a tangent parallel to a straight line connecting preceding and subsequent end points with respect to the above end point. Thus, the course end line can be made smooth at the split point.

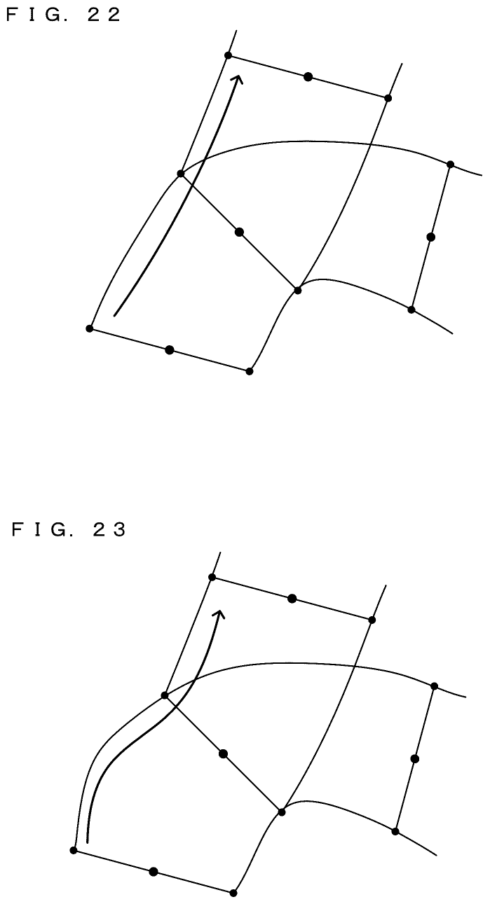

FIG. 22 shows an example when curves at a split point are calculated by the method shown in FIG. 21. FIG. 23 shows an example when curves at a split point are calculated by the method shown in FIG. 20.

As shown in FIG. 22, in the method shown in FIG. 21, i.e., a method of using a tangent parallel to a straight line connecting an end point at a split point and an immediate preceding end point, curves are smoothly connected at the split point. On the other hand, as shown in FIG. 23, in the method shown in FIG. 20, i.e., a method using a tangent parallel to a straight line connecting preceding and subsequent end points with respect to an end point at a split point, curves can have sharp change at the split point. Therefore, in the exemplary embodiment, for the split point, a curve representing a course end line is calculated using an end point at the split point and an immediate preceding end point.

Returning to FIG. 18, after the process in step S23, the processor 21 executes the assist process (step S24). Hereinafter, the details of the assist process will be described.

### Assist Process

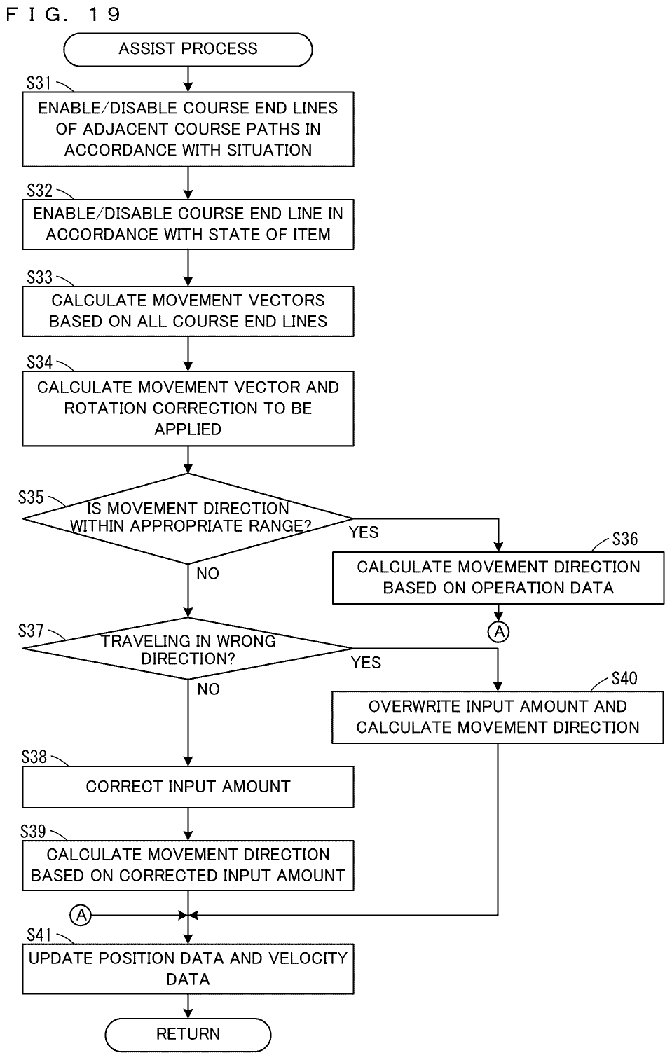

FIG. 19 is a flowchart showing an example of the assist process in step S24.

As shown in FIG. 19, the processor 21 enables or disables course end lines of adjacent course paths in accordance with the situation (step S31). Here, as described with reference to FIG. 8 to FIG. 10, the processor 21 determines whether or not to disable course end lines (assist walls), based on a lower end of a course path adjacent to a course path where the player object 50 is present and the position in the height direction of the player object 50. For example, as shown in FIG. 9 and FIG. 10, in a case where the lower end of the course path adjacent to the course path where the player object 50 is present is lower than the height of the player object 50, the processor 21 disables the course end lines (43R and 42L) present between the adjacent course paths.

Next, the processor 21 enables or disables a course end line in accordance with the state of an item (step S32). For example, as described with reference to FIG. 12, in a case where the player object 50 is in a state of being able to use a specific item X1 among a plurality of types of items, the processor 21 disables the course right end line 44R. Also in a case where the player object 50 is using the specific item X1, the processor 21 disables the course right end line 44R. On the other hand, as described with reference to FIG. 11, in a case where the player object 50 is not in a state of being able to use the item X1 and is not using the item X1, the processor 21 enables the course right end line 44R.

Next, the processor 21 calculates movement vectors based on all course end lines, using the course end information acquired in step S23 (step S33). As the player object 50 becomes farther from the course end line, the movement correction amount becomes smaller, and when the player object 50 is at a certain distance or longer from the course end line, the movement correction amount is zero. The direction of the movement vector is a direction not to approach the course end line, and is a direction to move away from the course end line or a direction along the course end line.

Next, the processor 21 calculates a movement vector and rotation correction to be applied to the player object 50, based on the results in steps S31 to S33 (step S34). In a case where there are a plurality of course paths, a course end line for which the movement correction amount becomes smallest is specified, and a movement vector based on the specified course end line is calculated. In addition, rotation correction based on the specified course end line is calculated.

Next, the processor 21 determines whether or not the movement direction of the player object 50 is within the appropriate range (step S35). Here, as described with reference to FIG. 13 and FIG. 14, whether or not the movement direction of the player object 50 is within the appropriate range defined by the straight lines La and Lb is determined.

If the movement direction of the player object 50 is within the appropriate range (step S35: YES), the processor 21 calculates the movement direction of the player object 50, based on the operation data (step S36). Specifically, the processor 21 calculates the movement direction of the player object 50, based on an input amount according to tilt in the left-right direction of the left analog stick 31.

On the other hand, if the movement direction of the player object 50 is not within the appropriate range (step S35: NO), the processor 21 determines whether or not the player object 50 is traveling in a wrong direction (step S37). For example, the processor 21 determines whether or not the angle between the movement direction of the player object 50 and the advancement direction on the course is greater than 90 degrees.

If the player object 50 is not traveling in a wrong direction (step S37: NO), the processor 21 corrects the input amount according to tilt in the left-right direction of the left analog stick 31 (step S38). Specifically, the processor 21 calculates a steering-wheel correction value so that the movement direction becomes within the appropriate range, based on the movement direction of the player object 50 and the appropriate range. The greater the difference between the movement direction of the player object 50 and the appropriate range is, the greater the absolute value of the calculated steering-wheel correction value is. For example, in the case shown in FIG. 13, the steering-wheel correction value is calculated so that the movement direction PD becomes close to the direction of the straight line La. Then, the processor 21 calculates a corrected input amount, based on the steering-wheel correction value and the input amount according to tilt in the left-right direction of the left analog stick 31.

Next, the processor 21 calculates the movement direction of the player object 50, based on the corrected input amount (step S39).

On the other hand, if the player object 50 is traveling in a wrong direction (step S37: YES), the processor 21 overwrites the acquired input amount and calculates the movement direction of the player object 50 (step S40). For example, as shown in FIG. 15, in a case where the movement direction of the player object 50 is deviated rightward relative to the advancement direction by greater than 90 degrees, the processor 21 corrects the input amount so that the movement direction is directed toward the advancement direction (in FIG. 15, directed toward the left side with respect to the movement direction). Irrespective of the value of the input amount according to tilt in the left-right direction of the left analog stick 31, the input amount is forcibly corrected so that the movement direction is directed toward the advancement direction. Then, the processor 21 calculates the movement direction of the player object 50, based on the corrected input amount. Alternatively, the movement direction of the player object 50 may be forcibly corrected.

In a case where the process in step S39 is performed or a case where the process in step S40 is performed, the processor 21 updates the position data and the velocity data (speed and movement direction) of the player object 50 (step S41). Specifically, the processor 21 updates the movement direction of the player object 50, based on the rotation correction calculated in step S34 and the movement direction calculated in step S36, step S39, or step S40, and stores the updated movement direction in the velocity data. In addition, the processor 21 updates the speed of the player object 50, based on information about whether or not an acceleration operation is performed, whether or not the player object 50 is traveling in a dirt area, and the like, and stores the updated speed in the velocity data. In addition, the processor 21 updates the position of the player object 50, based on the position of the player object 50, the velocity data (speed and movement direction), and the movement vector calculated in step S34. Specifically, the processor 21 updates the present position of the player object 50, based on the velocity data, and adds the movement vector calculated in step S34 to the updated position. Thus, the position of the player object 50 is corrected.

When the process in step S41 is performed, the processor 21 finishes the process in FIG. 19 and returns the process to FIG. 18.

Returning to FIG. 18, after the process in step S23 or after the process in step S22, the processor 21 performs an item related process (step S25). Here, the processor 21 determines whether or not the player object 50 has come into contact with an item acquisition object, and if the player object 50 has come into contact with an item acquisition object, the processor 21 randomly selects one of a plurality of types of items and causes the player object 50 to possess the selected item. In addition, in a case where the player object 50 is in a state of being able to use an item, the processor 21 determines whether or not an instruction for using the item is performed by the player, and if the instruction is performed, the processor 21 causes the player object 50 to use the item. When the player object 50 uses the item, the effect according to the type of the item is exerted for a predetermined period.

Next, the processor 21 performs a jump process (step S26). Here, the processor 21 determines whether or not an instruction for a jump action is performed, based on the operation data, and if the instruction is performed, the processor 21 causes the player object 50 to perform a jump action.

When the process in step S26 is performed, the processor 21 finishes the process shown in FIG. 18 and returns the process to FIG. 17.

Returning to FIG. 17, after the process in step S13, the processor 21 performs an opponent object control process (step S14). Here, as in the player object control process, the processor 21 performs a process for controlling movement of the opponent object 51. There are a case where the opponent object 51 is operated by another player and a case where the opponent object 51 is automatically controlled by the processor 21. In a case where the opponent object 51 is operated by another player, the processor 21 updates the position, the speed, the item possession state, and the like of the opponent object 51, based on data acquired from a controller other than the controller for operating the player object 50 or data acquired from another main body apparatus 2. In addition, the processor 21 causes the opponent object 51 to use an item or causes the opponent object 51 to perform a jump action, based on the acquired data.

Next, the processor 21 performs a rendering process (step S15). In the rendering process, the processor 21 generates a game image, based on a virtual camera set in back of the player object 50, and outputs the generated game image to a display apparatus (display 12 or external display apparatus).

Next, the processor 21 determines whether or not the player object 50 and the opponent object have reached the goal (step S16). If the player object 50 and the opponent object have reached the goal, the processor 21 displays a result of the racing game and finishes the process shown in FIG. 17. On the other hand, if the player object 50 and the opponent object have not reached the goal (step S16: NO), the processor 21 returns the process to step S12.

As described above, in the exemplary embodiment, in a case where the assist function is set at ON, movement correction for correcting the position of the player object 50 is performed based on the positional relationship between the player object 50 and a course end (steps S31 to S34 and S41). Specifically, in a case where the player object 50 is close to a course end, movement in a direction in which the player object 50 moves away from the course end is applied to the player object 50. Thus, it is possible to keep the player object 50 from deviating from the course. In addition, in the exemplary embodiment, whether or not the movement direction of the player object 50 is within the appropriate range is determined (step S35), and if the movement direction is not within the appropriate range, steering-wheel correction is performed (step S38). Thus, it is possible to perform correction so that the player object 50 moves toward a position advanced along the course path.

### Modification

While the exemplary embodiment has been described above, the above exemplary embodiment is merely an example, and the following modifications may be applied, for example.

For example, in the above exemplary embodiment, movement in a direction in which the player object 50 moves away from a course end is applied as the movement correction. In another exemplary embodiment, the movement correction may be such correction that the player object 50 does not come close to a course end. For example, the movement correction may be such correction that the player object 50 moves along the course end.

In the above exemplary embodiment, the position of the player object 50 is updated in accordance with the speed and the movement direction, and the movement vector is applied to the updated position, thus correcting movement of the player object 50. In another exemplary embodiment, movement of the player object 50 may be corrected by correcting the movement direction of the player object 50.

In the above exemplary embodiment, as course data for defining a course, data indicating path points and widths at the path points is prepared in advance, and ends of a course are defined based on the course data. In another exemplary embodiment, as the course data, data indicating both ends of a course may be prepared in advance, or data indicating one end and a width of a course may be prepared in advance. As the course data, data indicating a center line and a width of a course may be prepared in advance. As the course data, data indicating course end lines may be prepared in advance. That is, any data may be stored in advance as long as ends of a course can be defined by the data.

In the above exemplary embodiment, in a case where the player object 50 is in the first state, a plurality of course paths are merged and movement correction is performed based on an end on one side of a course path on the one side and an end on another side of a course path on the other side, among the plurality of course paths. In the above exemplary embodiment, in a case where the player object 50 is in the second state, movement correction is performed based on both ends of one course path in which the position of the player object 50 is included, among a plurality of course paths (FIG. 8). In the above exemplary embodiment, for example, the first state is a state in which the player object 50 is present on a plurality of overlapping course paths (FIG. 7), or a state in which, in a case where a higher course path and a lower course path are adjacent to each other, the player object 50 is present on the higher course path (FIG. 9). In the above exemplary embodiment, for example, the first state is a state in which, in a case where a higher course path and a lower course path are adjacent to each other, the height of the lower end of the course path in which the position of the player object is not included is equal to or smaller than the height of the position of the player object (FIG. 9 and FIG. 10). In the above exemplary embodiment, the first state is a state in which the player object 50 is using the item X1 or is able to use the item X1. In another exemplary embodiment, the first state may be a state in which the position of the player object 50 is included in a course path of a first type, and the second state may be a state in which the position of the player object 50 is included in a course path of a second type. That is, in another exemplary embodiment, the player object 50 may come into the first state or the second state in accordance with the type of the course path in which the position of the player object 50 is included.

In the above exemplary embodiment, based on the course right end line and the course left end line, movement correction is performed and rotation correction is performed. In another exemplary embodiment, only movement correction may be performed without performing rotation correction. In this case, the steering-wheel correction may be performed.

In the above exemplary embodiment, the course right end line and the course left end line are defined by curves (curved surfaces) calculated by drawing a tangent based on a plurality of discrete control points (course left ends and course right ends). The above curve calculation method is merely an example, and the curves may be calculated by another method. The course right end line and the course left end line may be defined by any curves (curved surfaces) prescribed by a plurality of discrete control points. In another exemplary embodiment, the course right end line and the course left end line may be lines obtained by connecting the control points by straight lines.

In the above exemplary embodiment, in a case where the movement direction of the player object 50 is not within the appropriate range between the first direction (the direction of the line La) and the second direction (the direction of the line Lb), the steering-wheel correction value is calculated so that the movement direction becomes close to the first direction or the second direction. In another exemplary embodiment, in a case where the movement direction of the player object 50 is not within the appropriate range, the steering-wheel correction value may be calculated so that the movement direction becomes close to the third direction included between the first direction and the second direction. The third direction may be a direction closer to the movement direction before correction, of the first direction and the second direction.

In the above exemplary embodiment, when the movement direction of the player object 50 is opposite to the advancement direction on the course, the input amount is corrected so that the movement direction is directed toward the advancement direction. In another exemplary embodiment, the movement direction of the player object 50 may be corrected so that the movement direction is directed toward the advancement direction.

In the above exemplary embodiment, the movement correction and the steering-wheel correction for the player object 50 are performed in the racing game. In another exemplary embodiment, the movement correction and the steering-wheel correction may be performed in any game in which the player object 50 is moved, instead of the racing game.

The above processes may be executed in another arbitrary information processing apparatus or information processing system, instead of the game system 1. The information processing system may be composed of a plurality of apparatuses, and the plurality of apparatuses may be connected via a network (e.g., LAN or the Internet).

The configurations according to the above exemplary embodiment and the modifications thereof may be combined together as desired as long as the configurations do not contradict each other. The above is merely an example of the exemplary embodiment, and various modifications and variations other than the above may be made.

While certain example systems, methods, devices and apparatuses have been described herein, it is to be understood that the appended claims are not to be limited to the systems, methods, devices and apparatuses disclosed, but on the contrary, are intended to cover various modifications and equivalent arrangements included within the spirit and scope of the appended claims.

What is claimed is:

1. One or more non-transitory computer-readable media having stored therein instructions that, when executed, cause one or more processors to execute game processing comprising:
based on an operation input, performing movement control for a player object in a field in a virtual space in which a course path indicating at least both ends of a course is defined along the course, the movement control including control to change a movement direction in accordance with at least an input amount; and
where both ends at a position on the course path advanced by a predetermined distance along the course path from a position of the player object during movement are defined as a first position and a second position, if the movement direction of the player object is not included between a first direction toward the first position from the position during the movement and a second direction toward the second position from the position during the movement, applying correction to the input amount so that the movement direction becomes close to a third direction included at least between the first direction and the second direction.

2. The one or more non-transitory computer-readable medium according to claim 1, wherein
the third direction is a direction closer to the movement direction before the correction, of the first direction and the second direction.

3. The one or more non-transitory computer-readable medium according to claim 1, wherein
the course includes a part splitting into a plurality of course paths,
the game processing comprising, in a case where a position on the course path advanced by a predetermined distance along the course path is at the splitting part, setting an end on one side of the course path that is on the one side as the first position and setting an end on another side of the course path on that is the other side as the second position.

4. The one or more non-transitory computer-readable medium according to claim 1, the game processing further comprising, in a case where the movement direction of the player object is deviated from an advancement direction on the course path by a predetermined criterion or more, correcting the input amount or the movement direction so that the movement direction of the player object becomes close to the advancement direction on the course path.

5. The one or more non-transitory computer-readable medium according to claim 1, wherein
the both ends of the course path are defined based on curves prescribed by a plurality of discrete control points.

6. An information processing system comprising a processor, the processor being configured to:
based on an operation input, perform movement control for a player object in a field in a virtual space in which a course path indicating at least both ends of a course is defined along the course, the movement control including control to change a movement direction in accordance with at least an input amount; and
where both ends at a position on the course path advanced by a predetermined distance along the course path from a position of the player object during movement are defined as a first position and a second position, if the movement direction of the player object is not included between a first direction toward the first position from the position during the movement and a second direction toward the second position from the position during the movement, apply correction to the input amount so that the movement direction becomes close to a third direction included at least between the first direction and the second direction.

7. The information processing system according to claim 6, wherein
the third direction is a direction closer to the movement direction before the correction, of the first direction and the second direction.

8. The information processing system according to claim 6, wherein
the course includes a part splitting into a plurality of course paths,
the processor being configured to, in a case where a position on the course path advanced by a predetermined distance along the course path is at the splitting part, set an end on one side of the course path that is on the one side as the first position and set an end on another side of the course path that is on the other side as the second position.

9. The information processing system according to claim 6, the processor being configured to further, in a case where the movement direction of the player object is deviated from an advancement direction on the course path by a predetermined criterion or more, correct the input amount or the movement direction so that the movement direction of the player object becomes close to the advancement direction on the course path.

10. The information processing system according to claim 6, wherein
the both ends of the course path are defined based on curves prescribed by a plurality of discrete control points.

11. An information processing method to be performed in an information processing system, the information processing method comprising:
based on an operation input, performing movement control for a player object in a field in a virtual space in which a course path indicating at least both ends of a course is defined along the course, the movement control including control to change a movement direction in accordance with at least an input amount; and
where both ends at a position on the course path advanced by a predetermined distance along the course path from a position of the player object during movement are defined as a first position and a second position, if the movement direction of the player object is not included between a first direction toward the first position from the position during the movement and a second direction toward the second position from the position during the movement, applying correction to the input amount so that the movement direction becomes close to a third direction included at least between the first direction and the second direction.

12. The information processing method according to claim 11, wherein
the third direction is a direction closer to the movement direction before the correction, of the first direction and the second direction.

13. The information processing method according to claim 11, wherein
the course includes a part splitting into a plurality of course paths,
the information processing method comprising, in a case where a position on the course path advanced by a predetermined distance along the course path is at the splitting part, setting an end on one side of the course path that is on the one side as the first position and setting an end on another side of the course path that is on the other side as the second position.

14. The information processing method according to claim 11, comprising, in a case where the movement direction of the player object is deviated from an advancement direction on the course path by a predetermined criterion or more, correcting the input amount or the movement direction so that the movement direction of the player object becomes close to the advancement direction on the course path.

15. The information processing method according to claim 11, wherein
the both ends of the course path are defined based on curves prescribed by a plurality of discrete control points.
